(19) United States
(12) Patent Application Publication
(10) Pub. No.: US 2004/0080677 A1
(43) Pub. Date: Apr. 29, 2004

(54) Optical engine and projection type display apparatus

(75) Inventor: Kenji Kamei, Kodama-gun (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/662,421

(22) Filed: Sep. 16, 2003

(30) Foreign Application Priority Data
Oct. 25, 2002 (JP) 2002-311474

(51) Int. Cl. G02F 1/1335

(52) U.S. Cl. 349/5; 349/113

(57) ABSTRACT

An optical engine which projects an image onto a screen has a housing, and in the housing, there are provided many optical elements such as a cross dichroic mirror, a plurality of reflection polarizing plates, a polarizing plate, a plurality of reflection type liquid crystal elements, a combining prism and others. Most of these optical elements provided in the housing are formed of inorganic materials. Since only the reflection type liquid crystal elements are formed of organic materials and hence require cooling, radiators are respectively provided to the reflection type liquid crystal elements, and these radiators are arranged integrally with the housing.

### CROSS-REFERENCE TO RELATED APPLICATIONS

This application is based upon and claims the benefit of priority from the prior Japanese Patent Application No. 2002-311474, filed Oct. 25, 2002, the entire contents of which are incorporated herein by reference.

### BACKGROUND OF THE INVENTION

1. Field of the Invention

The present invention relates to a structure which prevents foreign particles from entering an optical engine of a projection type display apparatus adopting reflection type liquid crystal elements.

2. Description of the Related Art

In recent years, there has been increased a need to further brightly and finely display data or the like on a large screen with the spread of personal computers and others, and a demand of a data projector, a household liquid crystal television or the like has been increased. Further, high-definition broadcasting such as high-vision broadcasting has begun to spread, and a need for realization of a high picture quality is increasing year by year.

Needs for realization of the high picture quality/large screen are increased as described above, and a development competition of the projection type display apparatus using various kinds of image display devices for both business and domestic uses has became popular aiming at brighter large screen.

A projection type display apparatus utilizing a liquid crystal display panel has been also actively developed in recent years based on such a background. A liquid crystal display panel can be roughly classified into a “transmission type” which transmits an incoming light ray therethrough and a “reflection type” which reflects an incoming light ray. Although a projection type display apparatus using a transmission type liquid crystal panel was conventionally a main stream, a high-definition reflection type liquid crystal panel (which will be referred to as a reflection type liquid crystal element hereinafter) to which fine processing is applied has been also developed and used in recent years.

Meanwhile, in the projection type display apparatus using the liquid crystal panel, in order to control a phase of the light entering the liquid crystal element or transmit the light in a predetermined oscillation direction, a phase difference plate or a polarizing plate is arranged with respect to the liquid crystal panel, thereby controlling a polarization characteristic. Optical elements such as the liquid crystal panel, the phase difference plate, the polarizing plate and others are used in an image projection portion of the projection type display apparatus, and this image projection portion is generally called an optical engine.

The phase difference plate or the polarizing plate is made of an organic plastic sheet, and its transmittance is not 100%. A light loss is therefore generated when the light is transmitted through the main body. Since this light loss becomes heat and it generates heat, a cooling device such as forced air cooling is usually required. In particular, in case of a household television, taking such a TV in Japan as an example, a life cycle of a product is a long term, i.e., 10 years, and long stable performances must be demonstrated. Therefore, cooling is essential.

An object of cooling is to avoid an inoperative state or prevent a material from being decomposed at a high temperature since the liquid crystal itself is a high molecular compound. Likewise, components such as the polarizing plate utilizing a high molecular compound, a PBS (bidirectional polarizing element), the phase difference plate are irradiated with the light with a high intensity and heated, and hence they are targets of cooling.

As a technique of cooling, the forced air cooling using a fan currently forms a main stream. Since cooling using an air stream increases an efficiency, a method which directly applies the air stream to the heat generation optical elements is good. However, when the heat generation optical components are directly exposed to the air stream, foreign particles/dust and others floating in air also enter the projection apparatus and deteriorate the transmittance of the optical elements, which results in bad performances as a degradation in brightness in a long term.

Furthermore, as the optical elements used in the optical engine of the projection type display apparatus, there are generally a lamp, a PCS (polarization conversion system), a dichroic mirror, a PBS (polarizing beam splitter), a phase difference plate, a liquid crystal element, a combining prism and others are used. In these components, those which require cooling is the lamp as a high-heat generation body, the PCS, the PBS, the phase difference plate and the liquid crystal element which are formed of materials including an organic material or an inorganic material.

On the other hand, Jpn. Pat. Appln. KOKAI Publication No. 8-234205 discloses a polarization illumination apparatus suitable as an illumination apparatus for the liquid crystal element in the projection type display apparatus in which a temperature intensively changes. According to the polarization illumination apparatus of this publication, there is described an example which emits polarizing light rays with the uniform brightness which can be practically utilized by aligning polarization direction of the polarizing light rays, which is thermally stabilized by utilizing an inorganic material for a polarization separation portion. However, this publication does not describe any countermeasure to prevent performances from being deteriorated when foreign particles/dust and the like have adhered to each optical element.

As mentioned above, in the conventional projection type display apparatus, although the parts requiring cooling are appropriately cooled by utilizing a fan and the like, foreign particles/dust are apt to adhere to the parts which are cooled by using the fan, and using these parts for a long time decreases the brightness, resulting in a degradation in performances.

Moreover, a ventilation path must be provided in a cooling structure using the fan, and a filter which prevents passage of foreign particles is attached in order to avoid the influence of the foreign particles which pass through the ventilation path. However, the fine dust adheres to a path portion of the light of the optical elements, which consequently provokes a reduction in an optical output of the optical engine.

### BRIEF SUMMARY OF THE INVENTION

One embodiment of the present invention may provide an optical engine which is used to modulate a light ray from a light source by using an image signal and projects it on a screen. The optical engine according to one aspect of the present invention includes a housing which forms a sealed space, and in the housing, there are provided: a light separation element which separates an incoming light ray from the light source into three primary color light rays; a plurality of reflection type liquid crystal elements which are arranged so as to receive the respective primary color light rays from the light separation element, and emit reflected light rays modulated by the image signal; a plurality of reflection polarizing plates to which the light rays separated by the light separation element enter, which reflect the incoming light rays and cause them to enter the respective liquid crystal elements and transmit the reflected light rays from the liquid crystal elements therethrough; and a combining prism which combines the light rays transmitted through a plurality of the reflection polarizing plates and emits a result.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a projection type display apparatus according to an embodiment of the present invention;

FIG. 2 is a view showing a structure of an optical engine 10;

FIG. 3 is an enlarged view showing an structure in a housing 25 of the optical engine 10; and

FIG. 4 is an enlarged view showing another embodiment of the optical engine 10.

### DETAILED DESCRIPTION OF THE INVENTION

An embodiment according to the present invention will now be described in detail with reference to the accompanying drawings. It is to be noted that an example of a rear projection type display apparatus will be described in the following embodiment, but the apparatus according to the present invention can be also applied to a front projection type display apparatus.

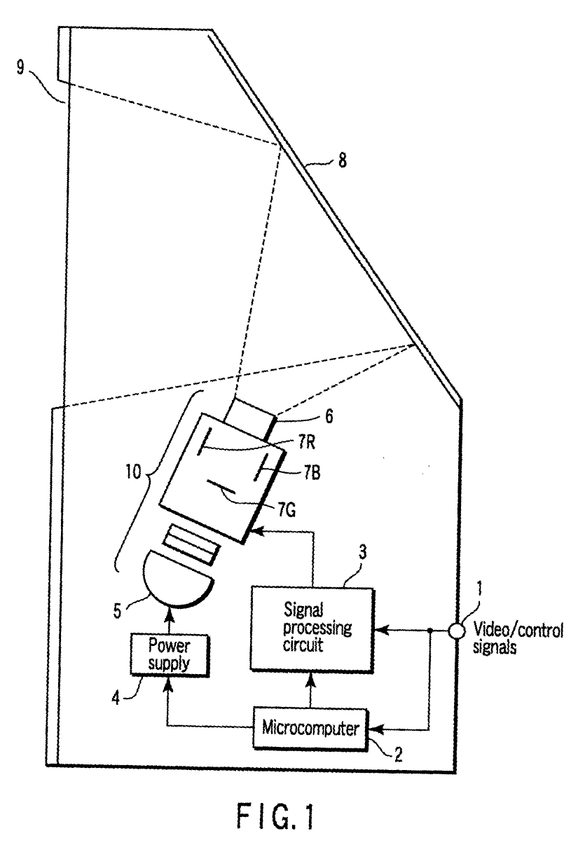

FIG. 1 is a block diagram showing a structure of a projection type display apparatus according to an embodiment of the present invention. Video and control signals inputted to a signal input terminal 1 are supplied to a microcomputer 2 and a signal processing circuit 3. The microcomputer 2 controls the signal processing circuit 3 and a lamp power supply 4 in accordance with a control signal inputted thereto.

The signal processing circuit 3 separates signals R, G and B included in the video signal inputted from the signal input terminal 1 from each other, and supplies them to an optical engine 10 as an image projection portion. The optical engine 10 includes reflection type liquid crystal elements 7R, 7G and 7B and a projection lens 6.

The liquid crystal elements 7R, 7G and 7B are driven by the video signal from the signal processing circuit 3 and reflects a light ray from a lamp 5, thereby generating an R (red) image, a G (green) image and a B (blue) image. The R (red) image, the G (green) image and the B (blue) image are combined with each other, then enlarged and projected by a projection lens 6, reflected by a mirror 8 and displayed on a screen 9.

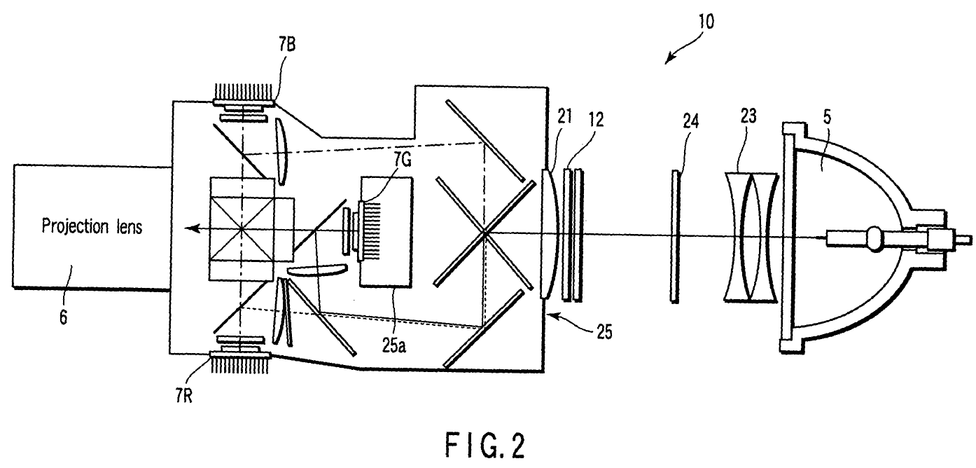

FIG. 2 is a view showing a structure of the optical engine 10. The optical engine 10 includes the lamp 5, a lens 23, an optical filter 24, a PCS multi lens 12, a housing 25 and the projection lens 6. The housing 25 is used to form a sealed space, and later-described optical elements are arranged in this sealed space. Moreover, a ventilation path 25a is provided to the housing 25.

The light emitted from the lamp 5 is condensed by the lens 23, unnecessary components such as an infrared ray or an ultraviolet ray are eliminated therefrom by the optical filter 24, and this light enters the PCS/multi lens 12. The PCS/multi lens 12 aligns polarization directions of the incoming light. That is, for example, the PCS/multi lens 12 converts a P polarizing light included in the incoming light into an S polarizing light, and transmits the S polarizing light therethrough as it is. As a result, only the S polarizing light outgoes from the PCS/multi lens 12. The light outgoing from the PCS/multi lens 12 passes through a correction lens 21 and enters the housing 25.

As apparent from FIG. 2, an incident opening for the light of the housing 25 is closed by the correction lens 21, and its outgoing radiation opening for the light of the same is closed by the projection lens 6, thereby forming the sealed space.

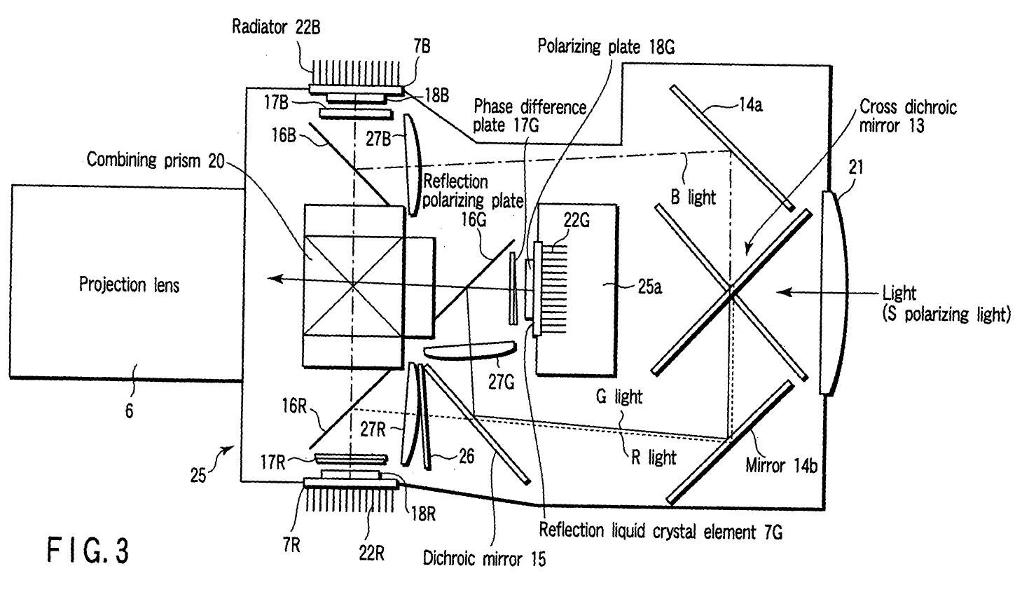

FIG. 3 is an enlarged view showing the inside of the housing 25. A structure of a primary part of the present invention will now be described in detail hereinafter with reference to FIG. 3.

The light (e.g., the S polarizing light) which has been transmitted through the correction lens 21 and entered the housing 25 is split into an RG light (light having red and green as main components) and a B light (light having blue as a main component) by a cross dichroic mirror 13. The split RG light is reflected by a mirror 14b and enters the dichroic mirror 15. The dichroic mirror 15 reflects the G light in the RG light, and transmits the R light therethrough.

The divided G light is reflected by a reflection polarizing plate 16G, transmitted through a phase difference plate 17G and a polarizing plate 18G, and enters a reflection type liquid crystal element 7G. The liquid crystal element 7G is driven by a video signal of G (green), and a transmitted light ray and a reflected light ray are determined by a polarization selection characteristic according to image information of the liquid crystal. The liquid crystal 7G is driven by a G image signal, and displays an image of a green component. The light reflected by the liquid crystal element 7G is again transmitted through the polarizing plate 18G and the phase difference plate 17G, and enters the reflection polarizing plate 16G. The reflection polarizing plate 16G has a characteristic to reflect the light from the dichroic mirror 15 and cause this light to enter the liquid crystal element 7G, and to transmit the light distorted by the liquid crystal element 7G therethrough. The light transmitted through the reflection polarizing plate 16G enters the combining prism 20.

The R light transmitted through the dichroic mirror 15 has an orange light component removed by a trimming filter 26, is further reflected by the reflection polarizing plate 16R, transmitted through the phase difference plate 17R and the polarizing plate 18R, and enters the reflection type liquid crystal element 7R. The liquid crystal element 7R is driven by an R video signal, and displays a video of a red component.

The light reflected by the liquid crystal element 7R is again transmitted through the polarizing plate 18R and the phase difference plate 17R, further transmitted through the reflection polarizing plate 16R, and enters the combining prism 20.

Likewise, the B light split by the cross dichroic mirror 13 is reflected by the mirror 14a and the reflection polarizing plate 16B, transmitted through the phase difference plate 17B and the polarizing plate 18B, and enters the reflection type liquid crystal element 7B. The liquid crystal element 7B is driven by the B video signal, and displays a video of a blue component. The light reflected by the liquid crystal element 7B is gain transmitted through the polarizing plate 18B and the phase difference plate 17B, further transmitted through the reflection polarizing plate 16B, and enters the combining prism 20. It is to be noted that reference characters 27G, 27B and 27R respectively denote lenses in FIG. 3.

The R, G and B light rays which have entered the combining prism 20 are combined with each other by the combining prism 20, enlarged by the projection lens 6, reflected by the mirror 8 in FIG. 1, and projected onto the screen 9. As a result, a color video is displayed on the screen 9.

As described above, in this embodiment, since the primary optical elements of the optical engine 10 are arranged in the housing 25, it is possible to prevent foreign particles or dust from adhering to the primary optical elements and the brightness from being reduced.

Further, of the optical elements in the housing 25, although a material consisting of an organic material was conventionally used for the reflection polarizing plate or the phase difference plate and the polarizing plate, these optical elements formed of an inorganic material have come into practical use in recent years. That is, although a PBS (polarizing beam splitter) consisting of an organic material and an inorganic material was conventionally used as the reflection polarizing plate 16, an inorganic reflection polarizing plate has come into practical use in recent years. Furthermore, the phase difference plate 17 was conventionally made of an organic material, but a use of crystal is possible nowadays. Likewise, the polarizing plate 18 was made of an organic material, an inorganic polarizing plate has come into practical use nowadays.

Therefore, the optical elements excluding the liquid crystal elements 7 arranged in the housing 25 can be all made of inorganic materials. That is, in this embodiment, the correction lens 21, the cross dichroic mirror 13, the mirror 14, the dichroic mirror 15 and the combining prism 20 are made of inorganic materials, and the reflection polarizing plate 16, the phase difference plate 17 and the polarizing plate 18 are also made of inorganic materials. Therefore, even if the inside of the housing 25 has a high temperature due to a thermal energy of the incoming light, the optical elements made of the inorganic materials have a high heat resistance, and hence they do not have to be cooled down. Alternatively, even if they are cooled down, a temperature countermeasure can be taken by just adding a simple radiator device.

In the present invention, the following structure is added as a cooling device. That is, in the housing 25, the reflection type liquid crystals 7 including an organic material must be cooled in particular. As to cooling of the reflection type liquid crystal elements, radiation can be facilitated by utilizing rear surfaces thereof. That is, the reflection type liquid crystal elements 7R, 7G and 7B are respectively fixed to radiators 22R, 22G and 22B, and the radiators 22R, 22G and 22B are attached on an outer surface of the housing 25.

These radiators 22R, 22G and 22B are subjected to natural air cooling or forced air cooling in accordance with a size of the optical engine 10 or a light generation quantity of the lamp 5. For example, like the radiator 22G provided in the ventilation path 25a, in regard to a part which cannot be sufficiently cooled by natural air cooling, an air stream may be applied to the ventilation path 25a by a fan in order to subject the radiator 22G to forced air cooling.

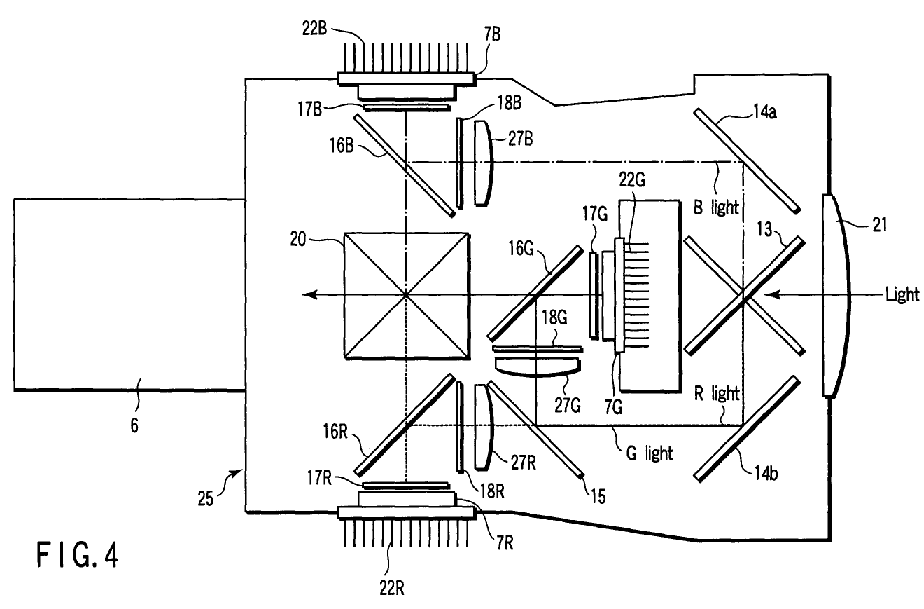

It is to be noted that the phase difference plate 17 and the polarizing plate 18 are not restricted to the illustrated positions, and they may be appropriately arranged in a light path extending to each liquid crystal element after light separation by the dichroic mirrors 13 and 15. FIG. 4 shows such an example.

In an embodiment of FIG. 4, the polarizing plates 18R, 18G and 18B are arranged on front stages of the reflection polarizing plates 16R, 16G and 16B after light separation using the dichroic mirrors 13 and 15, and the polarization characteristic of each liquid crystal element is controlled by these polarizing plates 18R, 18G and 18B and the phase difference plates 17R, 17G and 17B.

As described above, in this embodiment, many optical elements constituting the optical engine can be arranged within the housing in the sealed state. As a result, it is possible to realize a projection type display apparatus which can suppress foreign particles or dust from adhering to the optical elements, greatly improve a phenomenon of the brightness reduction and is stable for a long time. Furthermore, since areas requiring cooling are reduced by changing the optical elements to include inorganic materials, and the cooling system can be reduced in scale, thereby realizing a reduction in size of the apparatus and in cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An optical engine which modulates a light ray from a light source in accordance with an image signal and projects a result onto a screen, the optical engine comprising a housing forming a sealed space, there are provided in the housing:
a light separation element which separates an incoming light ray from the light source into three primary color light rays;
a plurality of reflection type liquid crystal elements which are arranged in such a manner that the respective three primary color light rays enter from the light separation element, and emit reflected light rays modulated by the image signal;
a plurality of reflection polarizing plates to which the light rays separated by the light separation element respectively enter, which causes the incoming light rays to enter the respective liquid crystal elements, and transmit therethrough the reflected light rays from the liquid crystal elements; and
a combining prism which combines the light rays transmitted through a plurality of the reflection polarizing plates and emits a resultant light ray.

2. The optical engine according to claim 1, wherein there are further provided a phase difference plate and a polarizing plate which are respectively arranged in light paths extending from the light separation element to the respective liquid crystal elements and used to control polarization characteristics of the respective liquid crystal elements.

3. The optical engine according to claim 1, wherein the housing includes an incident opening from which the light ray from the light source enters and an outgoing radiation opening from which the light ray from the combining prism outgoes, a sealed space is formed by closing the incident opening and the outgoing radiation opening by using lens members, and optical elements other than the reflection type liquid crystal elements provided in this sealed space are made of inorganic materials.

4. The optical engine according to claim 1, wherein the reflection type liquid crystal elements are fixed to radiators integrally attached to the housing, and heat from the radiators is radiated to the outside of the housing.

5. The optical engine according to claim 1, wherein a ventilation path is provided to an intermediate portion of the housing, and one of a plurality of the radiators is provided in the ventilation path.

6. An optical engine which modulates a light ray from a light source in accordance with an image signal and projects a result onto a screen, the optical engine comprising a housing forming a sealed space,
wherein there are provided in the housing:
a light separation element which includes a dichroic mirror and a reflection mirrors, and is used to separate an incoming light ray from the light source into R, G and B light rays;
a plurality of reflection type liquid crystal elements which are arranged in such a manner that the R, G and B light rays separated by the light separation element respectively enter thereto, and emit reflected light rays modulated by the image signal;
a plurality of reflection polarizing plates which are respectively arranged in light paths between the light separation element and the respective liquid crystal elements, to which the R, G and B light rays separated by the light separation element 13 respectively enter, which reflect the incoming light rays to enter the respective liquid crystal elements, and transmit reflected light rays from the liquid crystal elements therethrough; and
a combining prism which combines light rays transmitted through a plurality of the reflection polarizing plates and emits a resultant light ray.

7. The optical engine according to claim 6, wherein there are provided a phase difference plate and a polarizing plate which are respectively arranged in the light paths extending from the light separation element to the respective liquid crystal elements, and used to control polarization characteristics of the respective liquid crystal elements.

8. The optical engine according to claim 6, wherein the housing includes an incident opening from which the light ray from the light source enters and an outgoing radiation opening from which the light from the combining prism outgoes, a sealed space is formed by closing the incident opening and the outgoing radiation opening by using lens members, and optical elements except the reflection type liquid crystal elements provided in this sealed space are made of inorganic materials.

9. The optical engine according to claim 6, wherein the reflection type liquid crystal elements are fixed to radiators integrally attached to the housing, and heat from the radiators are radiated to the outside of the housing.

10. The optical engine according to claim 6, wherein a ventilation path is provided to an intermediate portion of the housing, and one of a plurality of the radiators is provided in the ventilation path.

11. A projection type display apparatus comprising:
a light source;
a housing having an incident opening from which a light ray from the light source enters and an outgoing radiation opening for the light ray;
a lens which is attached to the housing so as to close the incident opening and leads the light ray from the light source into the housing;
a light separation element which includes a dichroic mirror and a reflection mirror, and is used to separate the light which has entered through the incident opening into R, G and B light rays;
a plurality of reflection type liquid crystal elements which are arranged in such a manner that the R, G and B light rays separated by the light separation element respectively enter thereto, and emit reflected light rays modulated by an image signal;
a plurality of reflection polarizing plates which are respectively arranged in light paths between the light separation element and the respective liquid crystal elements, to which the R, G and B light rays separated by the light separation element respectively enter, which reflect the incoming light rays to enter the respective liquid crystal elements, and transmit reflected light rays from the liquid crystal elements therethrough;
a combining prism which combines the light rays transmitted through a plurality of the reflection polarizing plates and emits a resultant light ray; and
a projection lens which is attached to the outgoing radiation opening of the housing, used to project the light ray from the combining prism,
wherein optical elements including the light separation element, the reflection type liquid crystal elements, the reflection polarizing plates and the combining prism are arranged in the housing.

12. The projection type display apparatus according to claim 11, wherein the optical elements except the reflection type liquid crystal elements arranged in the housing are made of inorganic materials.

13. The projection type display apparatus according to claim 11, wherein the reflection type liquid crystal elements are fixed to radiators integrally attached to the housing, and heat from the radiators are radiated to the outside of the housing.
